(19) United States
(12) Patent Application Publication
(10) Pub. No.: US 2026/0312776 A1
(43) Pub. Date: Oct. 8, 2026

(54) Inter-Band Carrier Aggregation Enhancements

(71) Applicant: Apple Inc., Cupertino, CA (US)

(72) Inventors: Jie Cui, San Jose, CA (US); Yang Tang, San Jose, CA (US); Qiming Li, Beijing (CN); Xiang Chen, Palo Alto, CA (US); Dawei ZHANG, Saratoga, CA (US); Hong He, San Jose, CA (US)

(21) Appl. No.: 19/472,898

(22) PCT Filed: Apr. 7, 2023
(86) PCT No.: PCT/CN2023/086818

§ 371 Date: Oct. 6, 2025

(51) Int. Cl. H04L 5/00; H04B 7/08; H04W 72/044

(52) U.S. Cl. CPC H04L 5/0094; H04B 7/088; H04W 72/044

(57) ABSTRACT

Apparatuses, systems, and methods for inter-band carrier aggregation enhancements, such as for multiple receive chain capable UEs, e.g., in 5G NR systems and beyond. A UE may indicate, to a network node, a multi-receive chain configuration of the UE, e.g., via a UE capability. The UE may determine, based on information received from the network node, that at least one of an intra-band component carrier (CC) conflict or an inter-band CC conflict is occurring on at least one receive chain of the UE and determine a receive beam restriction (e.g., a scheduling restriction and/or a measurement restriction) to avoid at least one of the intra-band CC conflict or the inter-band CC conflict for the at least one receive chain. The UE may apply the receive beam restriction to the at least one receive chain, e.g., based on the determination.

### FIELD

The invention relates to wireless communications, and more particularly to apparatuses, systems, and methods for inter-band carrier aggregation enhancements, such as for multiple receive chain capable UEs, e.g., in 5G NR systems and beyond.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices now provide access to the internet, email, text messaging, and navigation using the global positioning system (GPS) and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for inter-band carrier aggregation enhancements, such as for multiple receive chain capable UEs, e.g., in 5G NR systems and beyond.

For example, in some embodiments, a UE may be configured to indicate, to a network node, a multi-receive chain configuration of the UE. The multi-receive chain configuration of the UE may be a UE capability. The UE capability may be a beamManagementTypewithMultiRxChain-r18 parameter, at least in some instances. In addition, the UE may be configured to determine, based on information received from the network node, that at least one of an intra-band component carrier (CC) conflict or an inter-band CC conflict is occurring on at least one receive chain of the UE. Further, the UE may be configured to determine a receive beam restriction (e.g., a scheduling restriction and/or a measurement restriction) to avoid at least one of the intra-band CC conflict or the inter-band CC conflict for the at least one receive chain and to apply the receive beam restriction to the at least one receive chain, e.g., based on the determination. Note that to apply the receive beam restriction to the at least one receive chain based on the determination, the UE may not receive on a beam indicated by the receive beam restriction. Additionally, the determination may be based, at least in part, on the multi-receive chain configuration of the UE.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example wireless communication system according to some embodiments.

FIG. 2 illustrates an example block diagram of a base station, according to some embodiments.

FIG. 3 illustrates an example block diagram of a server, according to some embodiments.

FIG. 4 illustrates an example block diagram of a UE, according to some embodiments.

FIG. 5 illustrates an example of a 5G network architecture that incorporates both dual 3GPP (e.g., LTE and 5G NR) access and non-3GPP access to the 5G CN, according to some embodiments.

FIGS. 6A, 6B, 6C illustrate examples of different UE implementations regarding multiple receive chains.

FIGS. 7, 8A, 8B, 9A, 9B, and 10 illustrate examples of various cases of a multi-receive chain UE applying a scheduling and/or measurement restriction when the UE has a first receive chain that covers a first spherical volume and all FR2-1 bands and a second receive chain that covers a second spherical volume and all FR2-1 bands, according to some embodiments.

FIG. 11 illustrates a block diagram of an example of a method for receive beam restriction determination, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
BS: Base Station
DL: Downlink
UL: Uplink
LTE: Long Term Evolution
NR: New Radio
5GS: 5G System
5GMM: 5GS Mobility Management
5GC/5GCN: 5G Core Network
SIM: Subscriber Identity Module
eSIM: Embedded Subscriber Identity Module
IE: Information Element
CE: Control Element
MAC: Medium Access Control
SSB: Synchronization Signal Block
PDCCH: Physical Downlink Control Channel
PDSCH: Physical Downlink Shared Channel
RRC: Radio Resource Control

### Terms

The following is a glossary of terms used in this disclosure:
Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc. ; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.
Carrier Medium—a memory medium as described above, as well as a physical transmission medium, such as a bus, network, and/or other physical transmission medium that conveys signals such as electrical, electromagnetic, or digital signals.
Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.
Base Station—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.
Band—The term “band” has the full breadth of its ordinary meaning, and at least includes a section of spectrum (e.g., radio frequency spectrum) in which channels are used or set aside for the same purpose.
Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.
Non-3GPP Access—refers any accesses (e.g., radio access technologies) that are not specified by 3GPP standards. These accesses include, but are not limited to, WiMAX, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.
Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.
Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

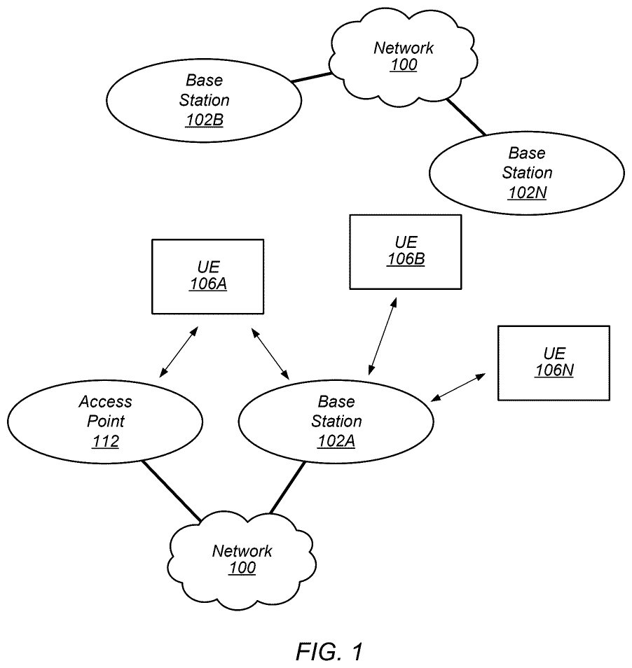

### FIG. 1: Communication System

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA 2000 (e.g., 1×RTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

In addition, the UE 106 may be in communication with an access point 112, e.g., using a wireless networking (e.g., Wi-Fi) and/or peer-to-peer wireless communication protocol (e.g., Bluetooth, Wi-Fi peer-to-peer, etc.). The access point 112 may provide a connection to the network 100.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA 2000 (e.g., 1×RTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

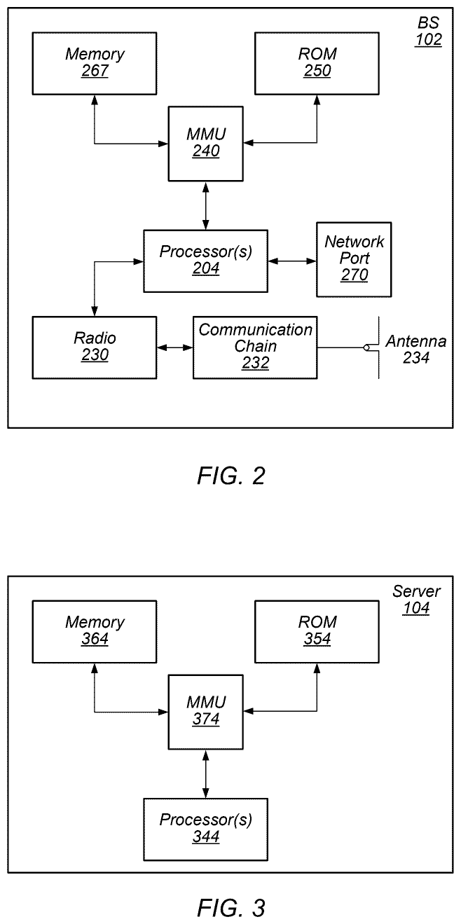

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (ICs) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (ICs) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (ICs) that are configured to perform the functions of processor(s) 344. In addition, each integrated circuit may include circuitry (e.g., first circuitry, second circuitry, etc.) configured to perform the functions of processor(s) 344.

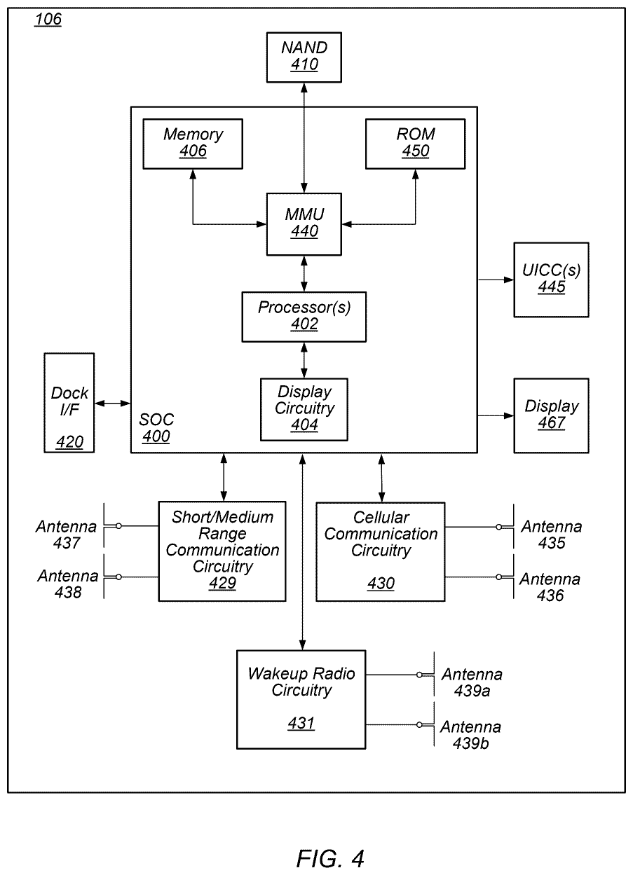

### FIG. 4: Block Diagram of a UE

FIG. 4 illustrates an example simplified block diagram of a communication device 106, according to some embodiments. It is noted that the block diagram of the communication device of FIG. 4 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, an unmanned aerial vehicle (UAV), a UAV controller (UAC) and/or a combination of devices, among other devices. As shown, the communication device 106 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106, and cellular communication circuitry 430 such as for 5G NR, LTE, GSM, etc., short to medium range wireless communication circuitry 429 (e.g., Bluetooth™ and WLAN circuitry), and wakeup radio circuitry 431. In some embodiments, communication device 106 may include wired communication circuitry (not shown), such as a network interface card, e.g., for Ethernet.

The cellular communication circuitry 430 may couple (e.g., communicatively; directly or indirectly) to one or more antennas, such as antennas 435 and 436 as shown. The short to medium range wireless communication circuitry 429 may also couple (e.g., communicatively; directly or indirectly) to one or more antennas, such as antennas 437 and 438 as shown. Alternatively, the short to medium range wireless communication circuitry 429 may couple (e.g., communicatively; directly or indirectly) to the antennas 435 and 436 in addition to, or instead of, coupling (e.g., communicatively; directly or indirectly) to the antennas 437 and 438. The wakeup radio circuitry 431may also couple (e.g., communicatively; directly or indirectly) to one or more antennas, such as antennas 439a and 439b as shown. Alternatively, the wakeup radio circuitry 431may couple (e.g., communicatively; directly or indirectly) to the antennas 435 and 436 in addition to, or instead of, coupling (e.g., communicatively; directly or indirectly) to the antennas 439a and 439b. The short to medium range wireless communication circuitry 429 and/or cellular communication circuitry 430 may include multiple receive chains and/or multiple transmit chains for receiving and/or transmitting multiple spatial streams, such as in a multiple-input multiple output (MIMO) configuration. The wakeup radio circuitry 431 may include a wakeup receiver, e.g., wakeup radio circuitry 431 may be a wakeup receiver. In some instances, wakeup radio circuitry 431 may be a low power and/or ultra-low power wakeup receiver. In some instances, wakeup radio circuitry may only be powered/active when cellular communication circuitry 430 and/or the short to medium range wireless communication circuitry 429 are in a sleep/no power/inactive state. In some instances, wakeup radio circuitry 431 may monitor (e.g., periodically) a specific frequency/channel for a wakeup signal. Receipt of the wakeup signal may trigger the wakeup radio circuitry 431 to notify (e.g., directly and/or indirectly) cellular communication circuitry 430 to enter a powered/active state.

In some embodiments, as further described below, cellular communication circuitry 430 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular communication circuitry 430 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106 may include at least two SIMs. Each SIM may execute one or more SIM applications and/or otherwise implement SIM functionality. Thus, each SIM may be a single smart card that may be embedded, e.g., may be soldered onto a circuit board in the UE 106, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”).

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for methods for sidelink control and synchronization reference signaling for SL PRS transmission, e.g., in 5G NR systems and beyond, as further described herein. For example, the communication device 106 may be configured to perform methods for CORESET #0 configuration, SSB/CORESET #0 multiplexing pattern 1 for mixed SCS, time-domain ROs determination for 480 kHz/960 kHz SCSs, and RA-RNTI determination for 480 kHz/960 kHz SCSs.

As described herein, the communication device 106 may include hardware and software components for implementing the above features for a communication device 106 to communicate a scheduling profile for power savings to a network. The processor 402 of the communication device 106 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (ICs) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (ICs) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more ICs that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

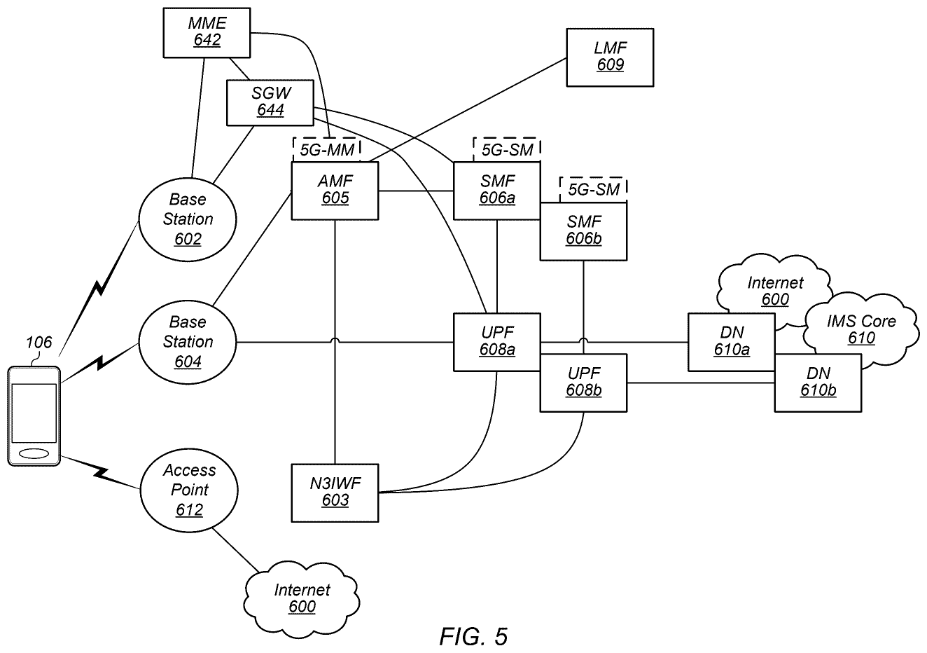

### FIG. 5: 5G Core Network Architecture—Interworking With Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 5 illustrates an example of a 5G network architecture that incorporates both dual 3GPP (e.g., cellular access via LTE and 5G-NR) and non-3GPP (e.g., non-cellular) access to the 5G CN, according to some embodiments. As shown, a user equipment device (e.g., such as UE 106) may access the 5G CN through both a radio access network (RAN, e.g., such as gNB 604 or eNB 602, each of which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106. In addition, the RAN (e.g., gNB 604) may also have a connection to the AMF 605. Thus, the 5G CN may support unified authentication over both connections as well as allow simultaneous registration for UE 106 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include functional entities associated with the 5G CN (e.g., such as a network slice selection function (NSSF), a short message service function 622, an application function (AF), unified data management (UDM), a policy control function (PCF), and/or an authentication server function. Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

Note that in various embodiments, one or more of the above-described entities may be configured to perform methods for inter-band carrier aggregation enhancements, such as for multiple receive chain capable UEs, e.g., in 5G NR systems and beyond, e.g., as further described herein. Current 3GPP Release 18 work items are focused on introducing necessary requirement(s) for enhanced Frequency Range 2 (FR2) part 1 (FR2-1) (e.g., FR2 covers frequencies ranging from 24250 megahertz (MHz) to 71000 MHz and is split into two ranges with FR2-1 covering 24250 MHz to 52600 MHz and FR2-2 covering 52600 MHz to 71000 MHz) UEs with simultaneous downlink (DL) reception from different directions with different quasi-collocation (QCL) TypeD reference signals (RSs) on a single component carrier. In particular, work items are focused on studying, and specifying as necessary, layer 1 (L1) reference signal received power (RSRP) measurement delay, radio link management and beam failure detection (BFD) and/or candidate beam detection (CBD) requirements, scheduling and/or measurement restrictions, Transmission Configuration Indication (TCI) state switching delay with dual TCI, and receive timing difference between different directions (e.g., different QCL Type D RSs).

Of the above, left for further study was whether such a UE can be configured with multiple component carriers (CCs), including intra-band CCs and/or inter-band CCs, when multi-Rx chain is enabled on only one of the component carriers. However, when coordinating parallel receive beams between CCs (e.g., one beam for each CC and/or each band) or on same CC (e.g., 2 beams on same CC and/or same band), to support such behavior, a UE capability associated with supporting parallel beams needs further clarification.

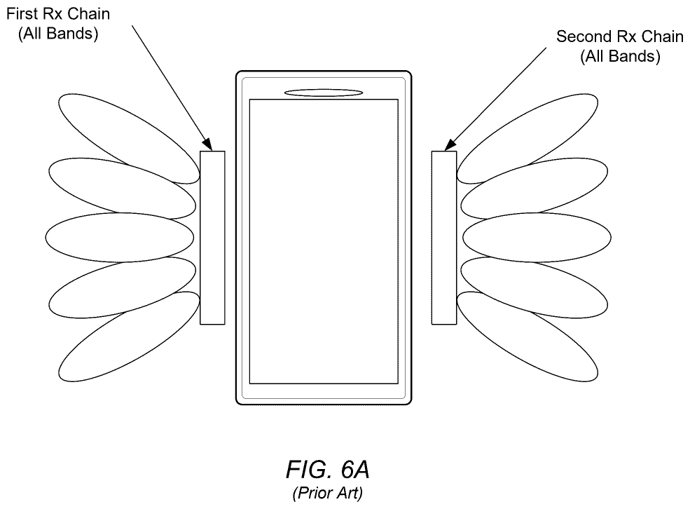

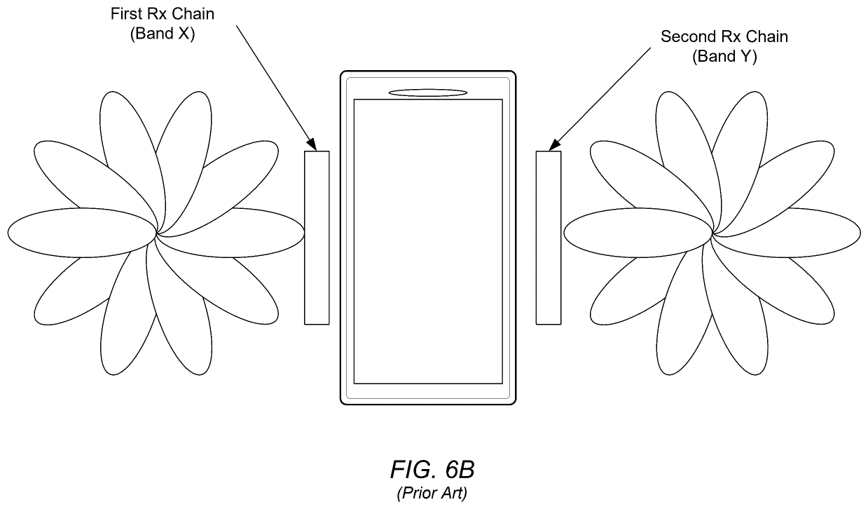

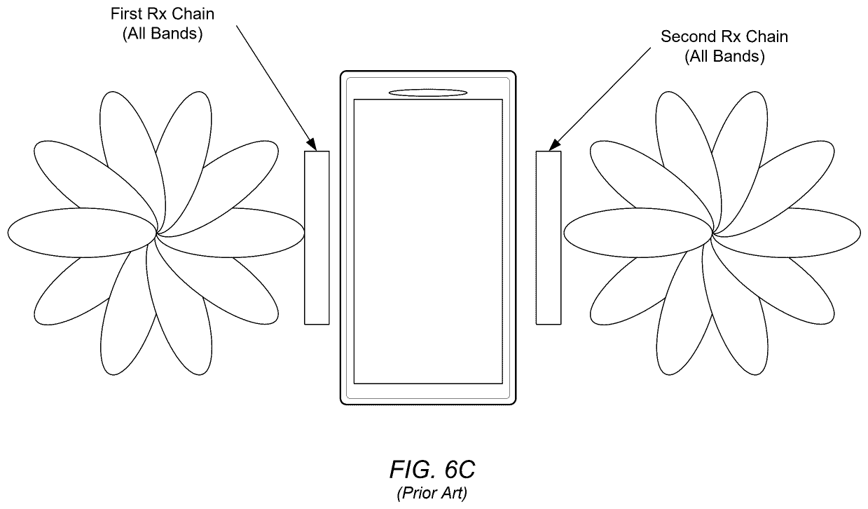

For example, as illustrated by FIGS. 6A, 6B, 6C, there may be different UE implementations regarding multiple receive chains. In some implementation, e.g., as shown in FIG. 6A, each panel (e.g., each receive chain) may cover a certain spherical volume but each panel may cover all bands. In some implementations, e.g., as shown in FIG. 6B, each panel (e.g., each receive chain) may cover a complete spherical volume, but each panel may only cover certain bands. In some implementations, e.g., as shown in FIG. 6C, each panel (e.g., each receive chain) may cover a complete spherical volume and each panel may cover all bands. Note that earlier releases of 3GPP, e.g., such as Release 16 and/or Release 17, specified independent beam management (IBM) as a UE capability. IBM allows a UE to support different beams between inter-band CCs but it's unclear how this capability is combined with multiple receive chain capability. Further, different capability UEs with inter-band carrier aggregation (CA) may exhibit different behaviors when a UE is working in inter-band CA with receive beam beamforming and network behavior may be different as well, e.g., such as L1 and/or layer 3 (L3) measurement on different CCs with different receive beams and scheduling on different CCs with different receive beams Thus, based on the UE capability, there may be scheduling and/or measurement restriction. For example, there may be a scheduling restriction for a band pair, e.g., when inter-band carrier aggregation in FR2 is performed, there are no scheduling restrictions on FR2 serving cells in the bands due to secondary synchronization signal (SS) RSRP (SS-RSRP), SS reference signal received quality (RSRQ) or SS signal to interference and noise ratio (SINR) measurement on an FR2 intra-frequency cell in different bands, provided that the UE is capable of independent beam management on this FR2 band pair (e.g., band combination) and there is no scheduling restriction if the UE is configured with different numerology between a synchronization signal block (SSB) on one FR2 band and data on the other FR2 band provided the UE is configured for IBM operation for the band pair. As another example, there may be a measurement restriction for a band pair, e.g., for FR2, when the SSB for radio link management (RLM) measurement on one CC is in the same orthogonal frequency division multiplexing (OFDM) symbol as a channel state information (CSI) reference signal (CSI-RS) for RLM, BFD, CBD or L1-RSRP measurement on the same CC or different CCs in the same band, the UE is required to measure one of, but not both of, SSB for RLM and CSI-RS (note that longer measurement period for SSB based RLM is expected and no requirements are currently defined). As a further example, for FR2, there is no measurement restriction allowed when the network configures mixed numerology between SSB for RLM measurement on one FR2 band and a CSI-RS for RLM, BFD, CBD, L1-RSRP or L1-SINR measurement on the other FR2 band, provided that UE is capable of independent beam management on this FR2 band pair.

Embodiments described herein provide systems, methods, and mechanisms for inter-band carrier aggregation enhancements, such as for multiple receive chain capable UEs, including systems, methods, mechanisms for a UE to indicate its multiple receive chain capability (e.g., via a UE capability) as well as scheduling and/or measurement restrictions between serving FR2-1 bands based on a UE's multiple receive chain capability. For example, when a UE has a first receive chain (e.g., antenna panel) that covers a first spherical volume and all FR2-1 bands and a second receive chain that covers a second spherical volume (e.g., different from the first spherical volume) and all FR2-1 bands, a scheduling and/or measurement restriction may apply when measurement and/or scheduling on different bands will use receive beams on a single receive chain (e.g., single panel) at the UE (e.g., either the first receive chain or the second receive chain). In such instances, the UE may indicate to the network such a capability and further indicate if such a case will happen with a beam combination (BC). The network may then check whether (e.g., if) measurement and/or scheduling on a single serving band will use receive beams on a single receive chain at the UE. Further, when (and/or if) the beam sweeping on the single serving band can use beams on different panels at the UE, then the network may configure the measurement and/or scheduling on one band and then to another band. However, when (and/or if) the beam sweeping on the single serving band will use beams on a single panel at the UE, then a measurement and/or scheduling restriction may apply between FR2 inter-bands. As another example, when a UE has a first receive chain (e.g., antenna panel) that covers a complete spherical volume and a first set of bands and a second receive chain that covers the complete spherical volume and a second set of bands (e.g., different from the first set of bands), measurement and/or scheduling on different bands may not use receive beams on a single panel at the UE. In such instances, the UE may indicate to the network such a capability and a scheduling and/or measurement restriction may only apply on a single FR2 band; but the scheduling and/or measurement restriction may not apply on different FR2-1 bands based on the indicated BC. Further, for other BCs, a scheduling and/or measurement restriction may apply. As a further example, when a UE has a first receive chain (e.g., antenna panel) that covers a complete spherical volume and all FR2-1 bands and a second receive chain also covers the complete spherical volume and all FR2-1 bands, measurement and/or scheduling on different bands may not use the same receive beams on a single receive chain at the UE. In such instances, measurement and/or scheduling on different bands is not able to use receive beams on a single panel at the UE. Further, in such instances, the UE may indicate to the network such a capability and a scheduling and/or measurement restriction application rule may be up to the different CA combination (e.g., conditions to avoid scheduling/measurement restriction on inter-band CC or intra-band CC may be defined). Further, when (and/or if) the UE uses two panels for two bands, then on each band, the UE may apply a scheduling and/or measurement restriction on intra-band CCs. Additionally, when (and/or if) the UE uses two panels for beams on the same band, then on each band the UE may not apply a scheduling and/or measurement restriction on intra-band CCs, however, the UE may apply a scheduling and/or measurement restriction on inter-band CCs.

In some instances, a UE capability, e.g., such as a beamManagementTypewithMultiRxChain-r18 parameter and/or another parameter with similar features, may indicate partial independent beam management (IBM) support and/or full (or complete) IBM support based on UE configuration. For example, when a UE, such as UE 106, has a first receive chain (e.g., antenna panel) that covers a first spherical volume and all FR2-1 bands and a second receive chain that covers a second spherical volume (e.g., different from the first spherical volume) and all FR2-1 bands, the UE may indicate support of partial IBM on specific band combinations. In such instances, the UE may cover part of a spherical volume and/or a subset of receive beams on each receive chain (and/or antenna panel); but each receive chain (and/or antenna panel) can cover a full list of bands. As another example, when a UE has a first receive chain (e.g., antenna panel) that covers a complete spherical volume and a first set of bands and a second receive chain that covers the complete spherical volume and a second set of bands (e.g., different from the first set of bands), the UE may indicate support of complete IBM on specific band combinations (e.g., different FR2-1 bands the UE can use different receive chains (and/or antenna panels) for receive beam beamforming). In such instances, the UE may cover an entire spherical volume and/or an entire set of receive beams on each receive chain (and/or antenna panel); but each receive chain (and/or antenna panel) may only cover certain bands. Note that when the UE indicates a specific BC for such an IBM, such an indication may imply (or mean) that one receive chain (and/or antenna panel) will cover one band and the other receive chain (and/or antenna panel) will cover the other band. As a further example, when a UE has a first receive chain (e.g., antenna panel) that covers a complete spherical volume and all FR2-1 bands and a second receive chain also covers the complete spherical volume and all FR2-1 bands, the UE may indicate support of complete IBM on specific band combinations. In such instances, the UE may cover an entire (or whole) spherical volume or an entire (or whole) set of receive beams on each receive chain (and/or antenna panel) and each receive chain (and/or antenna panel) may cover a full list of bands. Note that when the UE indicates a specific BC for such an IBM, such an indication may imply (or mean) that each receive chain (and/or antenna panel) can cover both bands.

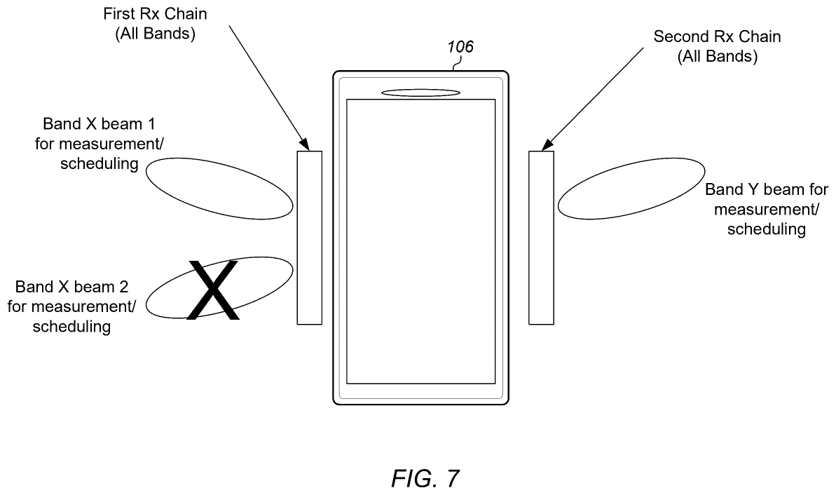

FIGS. 7, 8A, 8B, 9A, 9B, and 10 illustrate examples of various cases of a multi-receive chain UE applying a scheduling and/or measurement restriction when the UE has a first receive (Rx) chain (e.g., antenna panel) that covers a first spherical volume and all FR2-1 bands and a second receive chain that covers a second spherical volume (e.g., different from the first spherical volume) and all FR2-1 bands, according to some embodiments. Note that as described above, the UE may indicate such a capability (e.g., antenna panel/receive chain configuration) to a network. Further, as described above, the capability may indicate support of partial IBM on specific band combinations.

Turing to FIG. 7, shown is an example of an instance in which a UE, such as UE 106, is scheduled to receive different band beams on different receive chains (antenna panels) and multiple beams of a single band on a single receive chain (antenna panel), according to some embodiments. Thus, as shown, the UE is scheduled to receive a band X beam 1 for measurement and/or scheduling and a band X beam 2 for measurement and/or scheduling on a first receive chain and a band Y beam for measurement and/or scheduling on a second receive chain. In other words, the UE is scheduled to perform parallel measurement and/or scheduling between different bands (e.g., band X and band Y) and therefore, the UE may apply a measurement and/or scheduling restriction on intra-band CCs for band X (e.g., the UE may choose between beam 1 and beam 2 of band X for measurement and/or scheduling). In some instances, determination of which beam of which band to use for measurement and/or scheduling may be based on a maximum capacity rule (e.g., which beam can achieve maximum throughput), based on a specific CC type (e.g., whether a CC is primary CC (PCC) or a primary secondary CC (PSCC), based on a network configuration, and/or based on a network indication.

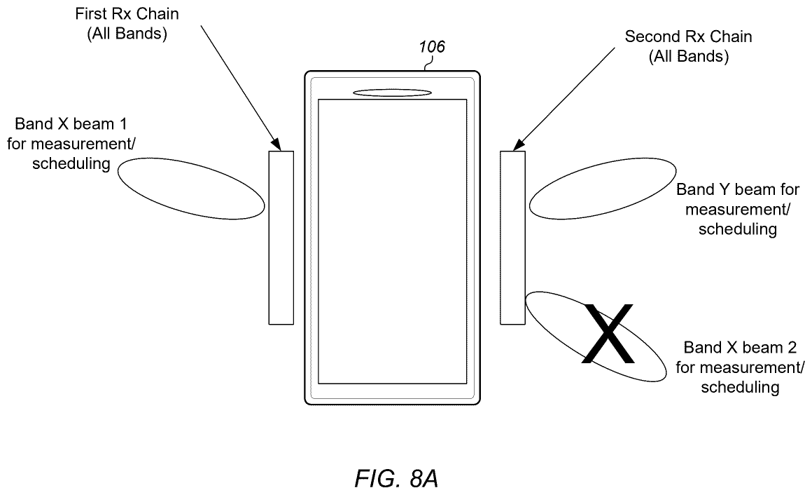

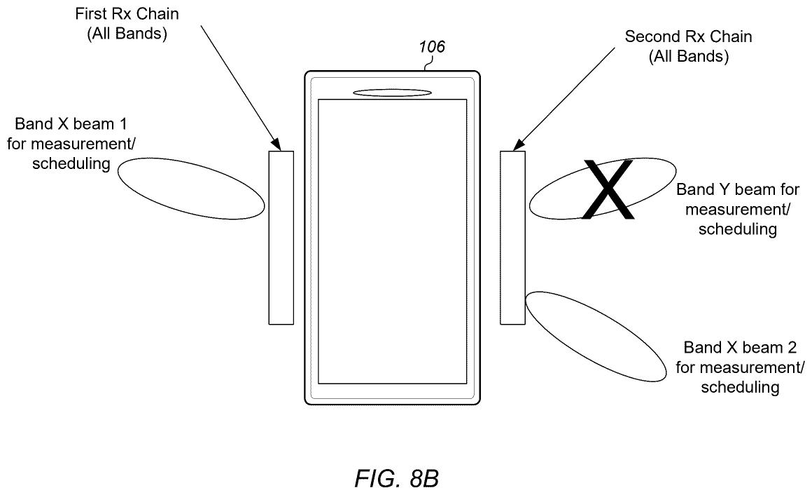

Turning to FIGS. 8A and 8B, shown are examples of instances in which a UE, such as UE 106, is scheduled to receive different band beams on different receive chains (antenna panels) and a single band beam on different receive chains (antenna panels), according to some embodiments. Thus, as shown, the UE is scheduled to receive band X beam 1 for measurement and/or scheduling on a first receive chain and a band X beam 2 for measurement and/or scheduling and a band Y beam for measurement and/or scheduling on a second receive chain. In other words, the UE is scheduled to perform parallel measurement and/or scheduling either between different bands (e.g., band X and Y) or on intra-band CCs (e.g., band X beam 1 and band X beam 2), and therefore, the UE may apply a measurement and/or scheduling restriction on intra-band CCs (e.g., FIG. 8A) or inter-band CCs (e.g., FIG. 8B). In some instances, determination of whether to apply the measurement and/or scheduling restriction on intra-band CCs or inter-band CCs may be based on a maximum capacity rule (e.g., which instance can achieve maximum throughput), a number of CCs on a specific band (e.g., when band X has more CCs than band Y, then the measurement and/or scheduling restriction may be applied to inter-band CCs, e.g., to minimize the impact of measurement and/or scheduling restriction), a specific CC type (e.g., when band X has PCC or PSCC, then prioritize band X CCs and then the measurement and/or scheduling restriction may be applied to inter-band CCs), based on a network configuration, and/or based on a network indication.

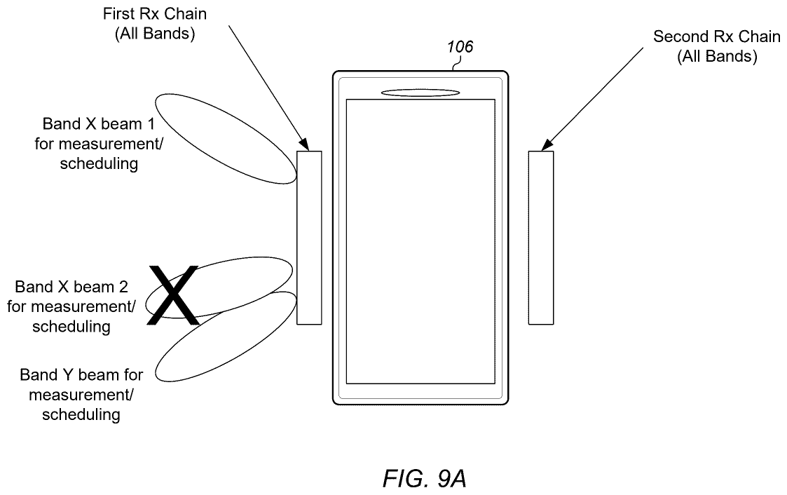

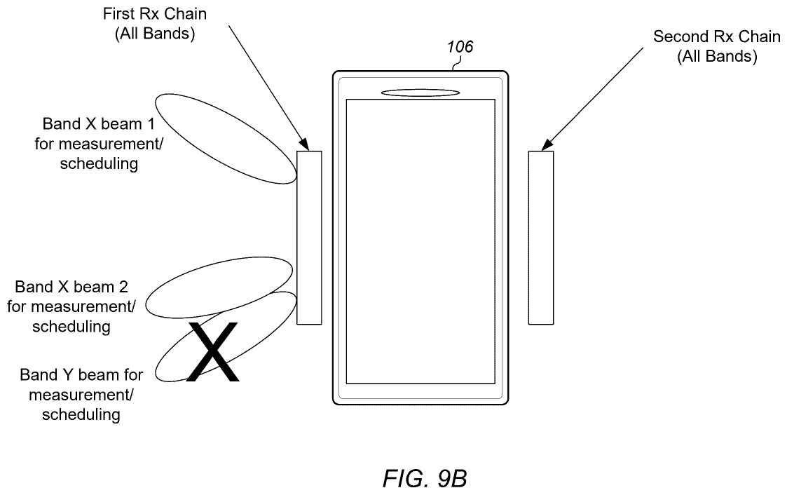

Turning to FIGS. 9A and 9B, shown are examples of instances in which a UE, such as UE 106, is scheduled to receive different band beams on a first receive chain (antenna panel) and a single band beam on the first receive chain (antenna panel), according to some embodiments. Thus, as shown, the UE is scheduled to receive a band X beam 1 for measurement and/or scheduling, a band X beam 2 for measurement and/or scheduling, and a band Y beam for measurement and/or scheduling a first receive chain. In other words, the UE is scheduled to perform parallel measurement and/or scheduling either between different bands (e.g., band X and Y) or on intra-band CCs (e.g., band X beam 1 and band X beam 2), and therefore, the UE may apply a measurement and/or scheduling restriction on intra-band CCs (e.g., FIG. 9A) or inter-band CCs (e.g., FIG. 9B). In some instances, determination of whether to apply the measurement and/or scheduling restriction on intra-band CCs or inter-band CCs may be based on a maximum capacity rule (e.g., which instance can achieve maximum throughput, a specific CC type (e.g., when band X has PCC or PSCC, then prioritize band X CCs and then the measurement and/or scheduling restriction may be applied to inter-band CCs), based on a network configuration, and/or based on a network indication.

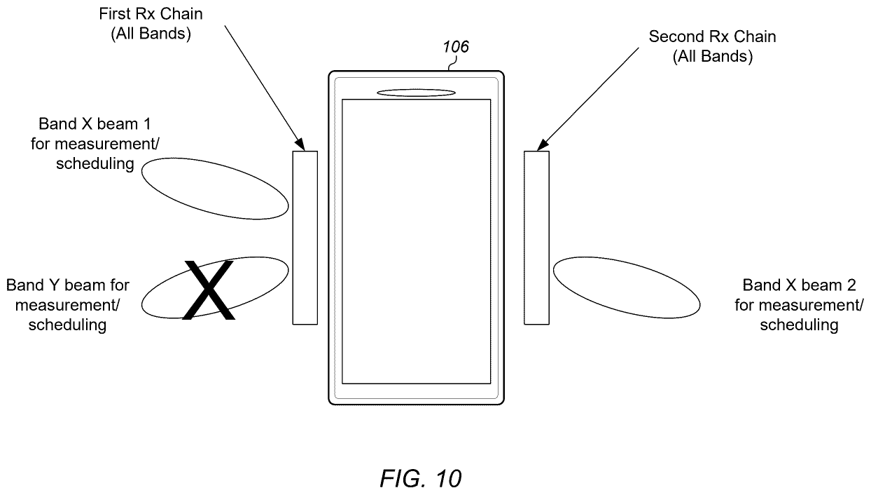

Turning to FIG. 10, shown is an example of an instance in which a UE, such as UE 106, is scheduled to receive different band beams on a first receive chain (antenna panels) and multiple beams of a single band on multiple receive chains (antenna panels), according to some embodiments. Thus, as shown, the UE is scheduled to receive a band X beam 1 for measurement and/or scheduling and a band Y for measurement and/or scheduling on a first receive chain and a band X beam 2 for measurement and/or scheduling on a second receive chain. In other words, the UE is scheduled to perform parallel measurement and/or scheduling on intra-band CCs for band X and inter-band CCs for bands X and Y, and therefore, may apply a measurement and/or scheduling restriction to inter-band CCs. In some instances, determination to apply the measurement and/or scheduling restriction on inter-band CCs may be based on a maximum capacity rule (e.g., which instance can achieve maximum throughput), a number of CCs on a specific band (e.g., when band X has more CCs than band Y, then the measurement and/or scheduling restriction may be applied to inter-band CCs, e.g., to minimize the impact of measurement and/or scheduling restriction), a specific CC type (e.g., when band X has PCC or PSCC, then prioritize band X CCs and then the measurement and/or scheduling restriction may be applied to inter-band CCs), based on a network configuration, and/or based on a network indication.

In some instances, when each receive chain (e.g., each antenna panel) of a UE, such as UE 106, covers a complete spherical volume but only certain FR2-1 bands, the UE may, as described above, indicate such a capability (e.g., antenna panel/receive chain configuration) to a network. Further, as described above, the capability may indicate support of complete IBM on specific band combinations. In such instances, the UE may use receive chains (e.g., antenna panels) for measurement/scheduling on different bands. Further, the UE may apply a scheduling and/or measurement restriction on a single FR2 band, e.g., on band X or band Y intra-band CCs, however, the UE may not apply a scheduling and/or measurement restriction on different FR2 band CCs based on the indicated band combination (BC). In other words, the UE may apply a scheduling and/or measurement restriction to intra-band CCs but not inter-band CCs on the indicated band combination. Note that for other band combinations, the UE may apply a scheduling and/or measurement restriction for inter-band CCs (e.g., for CCs not indicated by the band combination).

In some instances, when each receive chain (e.g., each antenna panel) of a UE, such as UE 106, covers a complete spherical volume and each receive chain covers all FR2-1 bands, the UE may, as described above, indicate such a capability (e.g., antenna panel/receive chain configuration) to a network. Further, as described above, the capability may indicate support of complete IBM on specific band combinations. In such instances, the UE may apply a scheduling and/or measurement restriction when scheduling and/or measuring on different bands (e.g., inter-band) or the same band (e.g., intra-band) will use receive beams on a single receive chain (antenna panel) of the UE. In such instances the UE may prioritize inter-band CCs (e.g., by apply a measurement and/or scheduling restriction on intra-band CCs) or intra-band CCs (e.g., by apply a measurement and/or scheduling restriction on inter-band CCs). Note that at least in some instances, a UE may consider beam separation for intra-band beams but not for inter-band beams. Thus, in at least some instances, if beam separation for intra-band beams for measurement and/or scheduling is below a threshold, the UE may prioritize inter-band CCs over intra-band CCs (e.g., by apply a measurement and/or scheduling restriction on intra-band CCs). Note that such a scheme may apply whether the intra-band beams are on the same receive chain (e.g., same antenna panel) or different receive chains (e.g., different antenna panels). In some instances, determination to apply the measurement and/or scheduling restriction on inter-band CCs or intra-band CCs may be based on a maximum capacity rule (e.g., which instance can achieve maximum throughput), a number of CCs on a specific band (e.g., when band X has more CCs than band Y, then the measurement and/or scheduling restriction may be applied to inter-band CCs, e.g., to minimize the impact of measurement and/or scheduling restriction), a specific CC type (e.g., when band X has PCC or PSCC, then prioritize band X CCs and then the measurement and/or scheduling restriction may be applied to inter-band CCs), based on a network configuration, and/or based on a network indication.

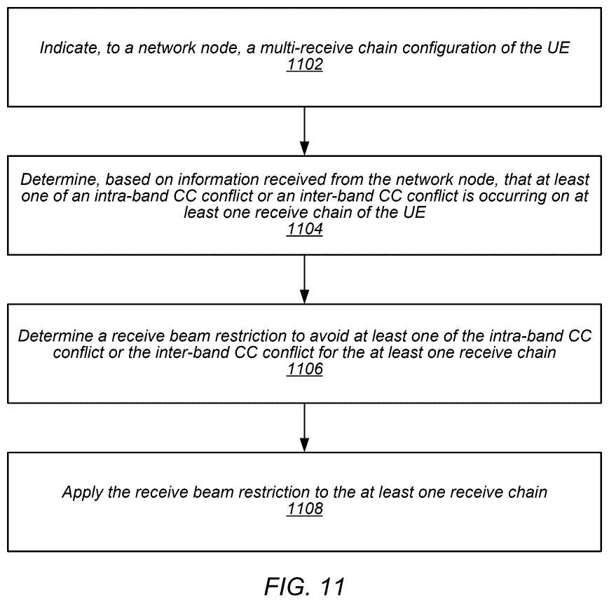

FIG. 11 illustrates a block diagram of an example of a method for receive beam restriction determination, according to some embodiments. The method shown in FIG. 11 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1102, a UE, such as UE 106, may indicate, to a network node, such as base station 102, a multi-receive chain (e.g., a multi-antenna panel) configuration of the UE. The multi-receive chain configuration of the UE may be a UE capability. The UE capability may be a beamManagementTypewithMultiRxChain-r18 parameter, at least in some instances.

At 1104, the UE may determine, based on information received from the network node, that at least one of an intra-band component carrier (CC) conflict or an inter-band CC conflict is occurring on at least one receive chain (e.g., at least one antenna panel) of the UE.

At 1106, the UE may determine a receive beam restriction to avoid at least one of the intra-band CC conflict or the inter-band CC conflict for the at least one receive chain (e.g., at least one antenna panel). The determination may be based, at least in part, on the multi-receive chain configuration of the UE. In some instances, to determine the receive beam restriction, the UE may determine the receive beam restriction based, at least in part, on at least one of (e.g., one or more of and/or any combination of) a maximum capacity rule, a number of CCs on a specific band, a specific CC type, a network configuration, and/or a network indication. In some instances, the maximum capacity rule may apply the restriction to the intra-band CC conflict when inter-band CCs are expected to achieve a higher throughput than intra-band CCs. In some instances, the maximum capacity rule may apply the restriction to the inter-band CC conflict with intra-band CCs are expected to achieve a higher throughput than inter-band CCs.

At 1108, the UE may apply the receive beam restriction to the at least one receive chain, e.g., based on the determination. In some instances, to apply the receive beam restriction to the at least one receive chain based on the determination, the UE may not receive on a beam indicated by the receive beam restriction. In some instances, the receive beam restriction may include at least one of a scheduling restriction or a measurement restriction on a beam indicated by the receive beam restriction.

In some instances, the multi-receive chain configuration may indicate support of partial independent beam management (IBM) on specific band combinations. In some instances, when the information received from the network node indicates that the UE is scheduled to receive multiple beams for scheduling or measurement for a first band on the at least one receive chain and a beam for scheduling or measurement for a second band on another receive chain of the UE, to apply the receive beam restriction, the UE may apply an intra-band CC receive beam restriction to one of the multiple beams of the first band on the at least one receive chain. In some instances, when the information received from the network node indicates that the UE is scheduled to receive a first beam of a first band and an additional beam from a second band on the at least one receive chain and a second beam of the first band on another receive chain of the UE, to apply the receive beam restriction, the UE may apply an intra-band CC receive beam restriction to the second beam of the first band on the at least one receive chain. In some instances, when the information received from the network node indicates that the UE is scheduled to receive a first beam of a first band and an additional beam from a second band on the at least one receive chain and a second beam of the first band on another receive chain of the UE, to apply the receive beam restriction, the UE may apply an inter-band CC receive beam restriction to the additional beam of the second band on the at least one receive chain. In some instances, when the information received from the network node indicates that the UE is scheduled to receive a first beam of a first band, a second beam of the first band, and an additional beam from a second band on the at least one receive chain, to apply the receive beam restriction, the UE may apply an intra-band CC receive beam restriction to the second beam of the first band on the at least one receive chain. In some instances, when the information received from the network node indicates that the UE is scheduled to receive a first beam of a first band, a second beam of the first band, and an additional beam from a second band on the at least one receive chain, to apply the receive beam restriction, the UE may apply an inter-band CC receive beam restriction to the additional beam of the second band on the at least one receive chain. In some instances, when the information received from the network node indicates that the UE is scheduled to receive a first beam of a first band and an additional beam from a second band on the at least one receive chain and a second beam of the first band on another receive chain of the UE, to apply the receive beam restriction, the UE may apply an inter-band CC receive beam restriction to the additional beam of the second band on the at least one receive chain.

In some instances, the multi-receive chain configuration may indicate support of complete independent beam management (IBM) on specific band combination. In such instances, a first receive chain of the UE covers an entire spherical volume and a first set of a lower portion of Frequency Range 2 (FR2-1) frequency bands and a second receive chain of the UE covers the entire spherical volume and a second set of FR2-1 frequency bands different than the first set of FR2-1 frequency bands. Further, in such instances, to apply the receive beam restriction, the UE may apply the receive beam restriction to intra-band CCs and inter-band CCs not indicated by the specific band combination.

In some instances, the multi-receive chain configuration may indicate support of complete independent beam management (IBM) on specific band combination. In such instances, a first receive chain of the UE covers an entire spherical volume and all Frequency Range 2 (FR2-1) frequency bands and a second receive chain of the UE covers the entire spherical volume and all FR2-1 frequency bands. Further, in such instances, to determine the receive beam restriction to avoid at least one of the intra-band CC conflict or the inter-band CC conflict for the at least one receive chain, the UE may determine whether beam separation for intra-band beams is below a threshold. In some instances, when beam separation for intra-band beams is below the threshold, to apply the receive beam restriction, the UE may apply the receive beam restriction to intra-band CCs.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for receive beam restriction determination, comprising:
a user equipment device (UE),
indicating, to a network node, a multi-receive chain configuration of the UE;
determining, based on information received from the network node, that at least one of an intra-band component carrier (CC) conflict or an inter-band CC conflict is occurring on at least one receive chain of the UE; and
determining a receive beam restriction to avoid at least one of the intra-band CC conflict or the inter-band CC conflict for the at least one receive chain based, at least in part, on the multi-receive chain configuration of the UE; and
applying the receive beam restriction to the at least one receive chain based on the determining.

2. The method of claim 1,
wherein determining the receive beam restriction comprises the UE determining the receive beam restriction based on at least one of:
a maximum capacity rule,
a number of CCs on a specific band,
a specific CC type,
a network configuration, or
a network indication.

3. The method of claim 2,
wherein the maximum capacity rule applies the restriction to the intra-band CC conflict when inter-band CCs are expected to achieve a higher throughput than intra-band CCs; and
wherein the maximum capacity rule applies the restriction to the inter-band CC conflict with intra-band CCs are expected to achieve a higher throughput than inter-band CCs.

4. The method of claim 1,
wherein the multi-receive chain configuration indicates support of partial independent beam management (IBM) on specific band combinations.

5. The method of claim 4,
wherein, when the information received from the network node indicates that the UE is scheduled to receive multiple beams for scheduling or measurement for a first band on the at least one receive chain and a beam for scheduling or measurement for a second band on another receive chain of the UE, applying the receive beam restriction comprises the UE applying an intra-band CC receive beam restriction to one of the multiple beams of the first band on the at least one receive chain.

6. The method of claim 4,
wherein, when the information received from the network node indicates that the UE is scheduled to receive a first beam of a first band and an additional beam from a second band on the at least one receive chain and a second beam of the first band on another receive chain of the UE, applying the receive beam restriction comprises the UE applying an intra-band CC receive beam restriction to the second beam of the first band on the at least one receive chain.

7. The method of claim 4,
wherein, when the information received from the network node indicates that the UE is scheduled to receive a first beam of a first band and an additional beam from a second band on the at least one receive chain and a second beam of the first band on another receive chain of the UE, applying the receive beam restriction comprises the UE applying an inter-band CC receive beam restriction to the additional beam of the second band on the at least one receive chain.

8. The method of claim 4,
wherein, when the information received from the network node indicates that the UE is scheduled to receive a first beam of a first band, a second beam of the first band, and an additional beam from a second band on the at least one receive chain, applying the receive beam restriction comprises the UE applying an intra-band CC receive beam restriction to the second beam of the first band on the at least one receive chain.

9. The method of claim 4,
wherein, when the information received from the network node indicates that the UE is scheduled to receive a first beam of a first band, a second beam of the first band, and an additional beam from a second band on the at least one receive chain, applying the receive beam restriction comprises the UE applying an inter-band CC receive beam restriction to the additional beam of the second band on the at least one receive chain.

10. The method of claim 4,
wherein, when the information received from the network node indicates that the UE is scheduled to receive a first beam of a first band and an additional beam from a second band on the at least one receive chain and a second beam of the first band on another receive chain of the UE, applying the receive beam restriction comprises the UE applying an inter-band CC receive beam restriction to the additional beam of the second band on the at least one receive chain.

11.-20. (canceled)

21. A user equipment device (UE), comprising:
two or more receive chains; and
at least one processor in communication with the two or more receive chains and configured to cause the UE to perform operations comprising:
indicating, to a network node, a multi-receive chain configuration of the UE;
determining, based on information received from the network node, that at least one of an intra-band component carrier (CC) conflict or an inter-band CC conflict is occurring on at least one receive chain of the UE; and
determining a receive beam restriction to avoid at least one of the intra-band CC conflict or the inter-band CC conflict for the at least one receive chain based, at least in part, on the multi-receive chain configuration of the UE; and
applying the receive beam restriction to the at least one receive chain based on the determining.

22. The UE of claim 21,
wherein the multi-receive chain configuration indicates support of complete independent beam management (IBM) on specific band combination.

23. The UE of claim 22,
wherein a first receive chain of the UE covers an entire spherical volume and a first set of a lower portion of Frequency Range 2 (FR2-1) frequency bands; and
wherein a second receive chain of the UE covers the entire spherical volume and a second set of FR2-1 frequency bands different than the first set of FR2-1 frequency bands.

24. The UE of claim 23,
wherein applying the receive beam restriction comprises the UE applying the receive beam restriction to intra-band CCs and inter-band CCs not indicated by the specific band combination.

25. The UE of claim 22,
wherein a first receive chain of the UE covers an entire spherical volume and all Frequency Range 2 (FR2-1) frequency bands; and
wherein a second receive chain of the UE covers the entire spherical volume and all FR2-1 frequency bands.

26. A baseband processor, comprising:
a memory; and
processing circuitry in communication with the memory and configured to cause a wireless device to perform operations comprising:
indicating, to a network node, a multi-receive chain configuration of the wireless device;
determining, based on information received from the network node, that at least one of an intra-band component carrier (CC) conflict or an inter-band CC conflict is occurring on at least one receive chain of the wireless device; and
determining a receive beam restriction to avoid at least one of the intra-band CC conflict or the inter-band CC conflict for the at least one receive chain based, at least in part, on the multi-receive chain configuration of the wireless device; and
applying the receive beam restriction to the at least one receive chain based on the determining.

27. The baseband processor of claim 26,
wherein a first receive chain of the wireless device covers an entire spherical volume and all Frequency Range 2 (FR2-1) frequency bands;
wherein a second receive chain of the wireless device covers the entire spherical volume and all FR2-1 frequency bands; and
wherein, to cause the wireless device to perform the operation of determining the receive beam restriction to avoid at least one of the intra-band CC conflict or the inter-band CC conflict for the at least one receive chain, the processing circuitry is further configured to cause the wireless device to perform operations comprising determining whether beam separation for intra-band beams is below a threshold.

28. The baseband processor of claim 27,
wherein, when beam separation for intra-band beams is below the threshold, to cause the wireless device to perform the operation of applying the receive beam restriction, co the processing circuitry is further configured to cause the wireless device to perform operations comprising applying the receive beam restriction to intra-band CCs.

29. The baseband processor of claim 26,
wherein applying the receive beam restriction to the at least one receive chain based on the determining comprises not receiving on a beam indicated by the receive beam restriction.

30. The baseband processor of claim 26,
wherein the receive beam restriction comprises at least one of a scheduling restriction or a measurement restriction on a beam indicated by the receive beam restriction.
